(19) United States
(12) Patent Application Publication
(10) Pub. No.: US 2018/0285893 A1
(43) Pub. Date: Oct. 4, 2018

(54) DETERMINING MUSIC TO INFLUENCE CUSTOMER BEHAVIOR

(71) Applicant: International Business Machines Corporation, Armonk, NY (US)

(72) Inventors: Marco A. Deluca, Maple (CA); Timothy M. Francis, Newmarket (CA); Leho Nigul, Richmond Hill (CA)

(21) Appl. No.: 15/476,144

(22) Filed: Mar. 31, 2017

(51) Int. Cl. G06Q 30/02

(52) U.S. Cl. CPC G06Q 30/0201

(57) ABSTRACT

An approach using one or more computers to determine music to influence customer behavior, the approach includes retrieving customer behavior in a retail location and data associated with music played in the retail location where the retail location is one of a plurality of retail locations. The approach includes correlating, by time, customer behavior in the retail location with the data associated with music played in the retail location for each retail location. The approach includes receiving a request for one or more desired customer behaviors in at least one of the plurality of retail locations and determining music that provides the desired customer behaviors. The approach includes providing a recommendation of the music that provides the desired customer behaviors to the retail locations associated with the request for the desired customer behaviors.

### BACKGROUND OF THE INVENTION

The present invention relates generally to the field of marketing and more particularly to determining music to influence customer behavior.

Consumer research indicates the influence of music reaches beyond enjoyment and influences various human behaviors. In various studies, psychologists are using environmental psychology and consumer psychology to study the relationship between human behavior and music in advertising. Typically, these studies provide an understanding of how music can effect advertising results. The field of consumer research includes the collection of information on what products consumers buy, why consumers buy a product, and information on a consumer purchasing a product to determine factors that influence consumer decisions on purchases. In general, the study of consumer purchasing decisions and the factors influencing a purchasing decision are very important to businesses developing new products, marketing, and selling products and services to consumers.

### SUMMARY

Embodiments of the present invention disclose a method, a computer program product, and a system for one or more computers to determine music to influence customer behavior, the method includes retrieving customer behavior in a retail location and data associated with music played in the retail location, wherein the retail location is one of a plurality of retail locations. The method includes the one or more computers correlating, by time, customer behavior in the retail location with the data associated with music played in the retail location for each retail location of the plurality of retail locations. Additionally, the method includes the one or more computers receiving a request for one or more desired customer behaviors in at least one of the plurality of retail locations and determining music that provides the one or more desired customer behaviors. The method includes one or more computers providing a recommendation of the music that provides the one or more desired customer behaviors to the at least one of the plurality of retail locations associated with the request for the one or more desired customer behaviors.

### BRIEF DESCRIPTION OF THE DRAWINGS

FIG. 1 is a functional block diagram illustrating a distributed data processing environment, in accordance with an embodiment of the present invention.

FIG. 2 is an illustration of an example of data exchanged between a store server and a server hosting a cognitive merchandising program, in accordance with an embodiment of the present invention.

FIG. 3 is a flow chart depicting a method for a cognitive analysis program to evaluate background music as a merchandising parameter influencing customer behavior, in accordance with an embodiment of the present invention.

FIG. 4 is a block diagram depicting components of a computer system in a distributed data processing environment, in accordance with an embodiment of the present invention.

FIG. 5 depicts a cloud computing environment, in accordance with an embodiment of the present invention.

FIG. 6 depicts abstraction model layers, in accordance with an embodiment of the present invention.

### DETAILED DESCRIPTION

Embodiments of the present invention recognize that retailers desire to influence customers and customer behavior to improve sales and customer traffic in retail locations. Embodiments of the present invention provide a method for a cognitive merchandising system to receive from one or more retail locations data on background music played in the retail location. Embodiments of the present invention include the data on background music played in each retail location including one or more of the following: a time of play, a list of music played, a file of digital music played, a music service utilized, a music style, a music genre, a music tempo, a location played, a volume played, and the like.

Embodiments of the present invention provide a method for a cognitive merchandising system to receive data on customer behavior observed in one or more retail locations and a time associated with the observed customer behavior. Embodiments of the present invention provide a method to correlate data on observed customer behavior in a retail location with data on background music played in the retail location using a time or a timestamp associated with each of the observed customer behavior and the background music played. Embodiments of the present invention provide a method to aggregate and analyze the correlated customer behavior and background music played to determine patterns between observed customer behaviors and corresponding background music in one or more associated retail locations.

Embodiments of the present invention provide a method for automatically analyzing and determining a recommendation for background music for one or more retail locations associated with or most likely to trigger one or more desired customer behaviors. The one or more desired customer behaviors may be either received from a user input or retrieved as a default or pre-determined customer behavior. Embodiments of the present invention provide a method for a cognitive merchandising system to introspect the aggregated and correlated data on observed customer behavior and background music played to determine one or more musical elements, such as tempo or volume, music type, or location played most likely to trigger desired customer behaviors. Embodiments of the present invention provide the ability for the cognitive merchandising system to send a recommendation for background music to one or more retail locations associated with a request for one or more desired customer behaviors. Embodiments of the present invention provide a method for a cognitive merchandising system using machine learning to recognize trends in analyzed data and determine trends resulting from multiple analyses of correlated customer behaviors and music to automatically provide changes to recommended background music to trigger one or more desired customer behaviors in one or more retail locations.

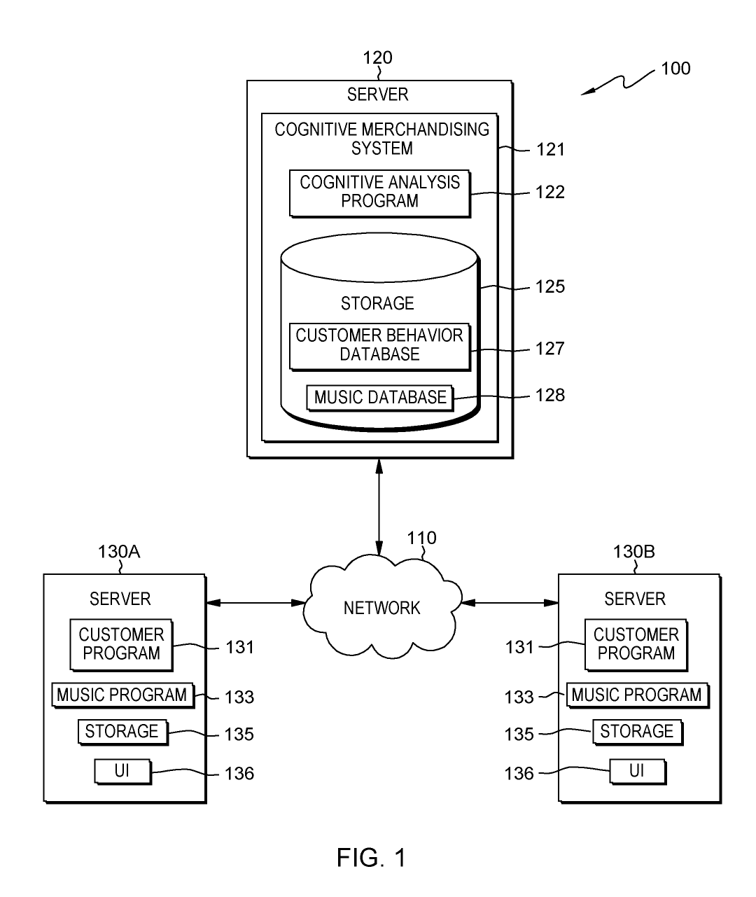

FIG. 1 is a functional block diagram illustrating a distributed data processing environment 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

As depicted, distributed data processing environment 100 includes servers 120, 130A, and 130B interconnected over network 110. Network 110 can include, for example, a telecommunications network, a local area network (LAN), a virtual LAN (VLAN), a wide area network (WAN), such as the Internet or a combination of these and can include wired or wireless connections. Network 110 can include one or more wired and/or wireless networks that are capable of receiving and transmitting data, such as a data on observed customer behavior or a recommended music playlist. In general, network 110 can be any combination of connections and protocols that will support communications between servers 120, 130A, and 130B, and other computing devices (not shown) within distributed data processing environment 100.

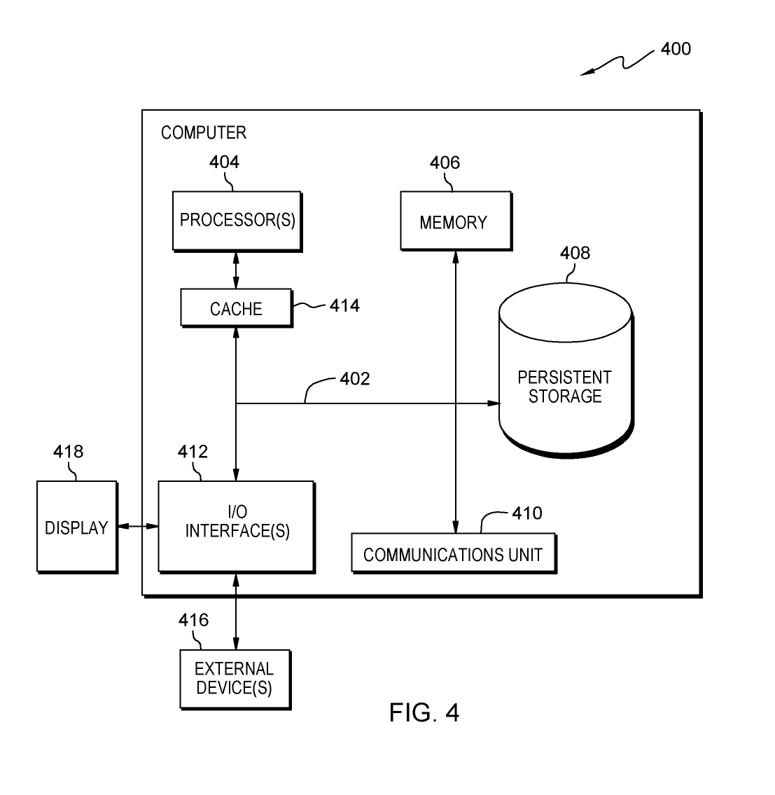

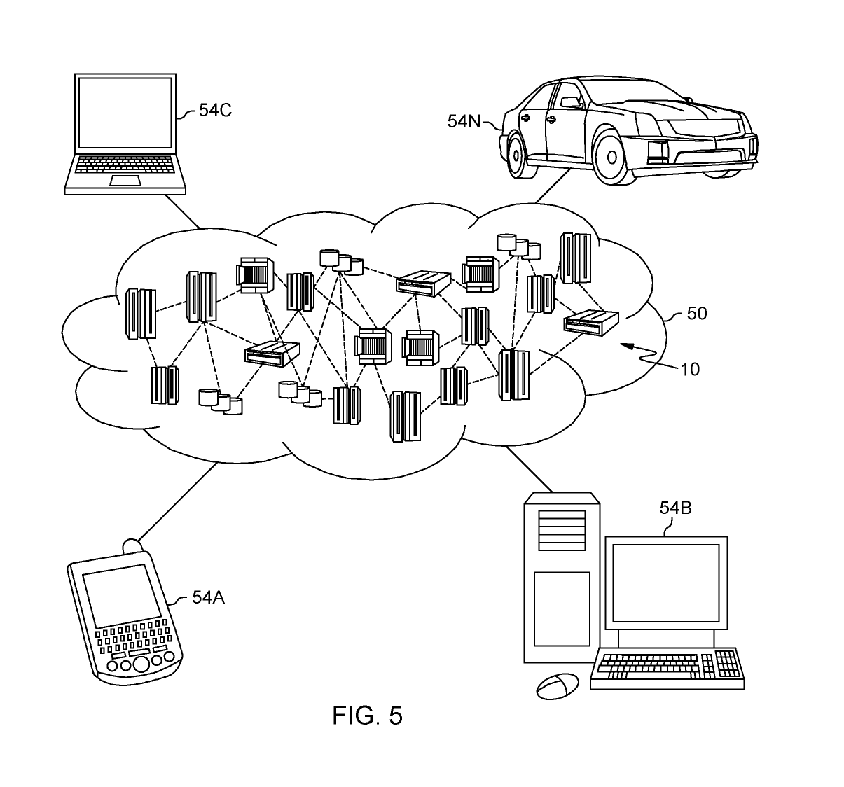

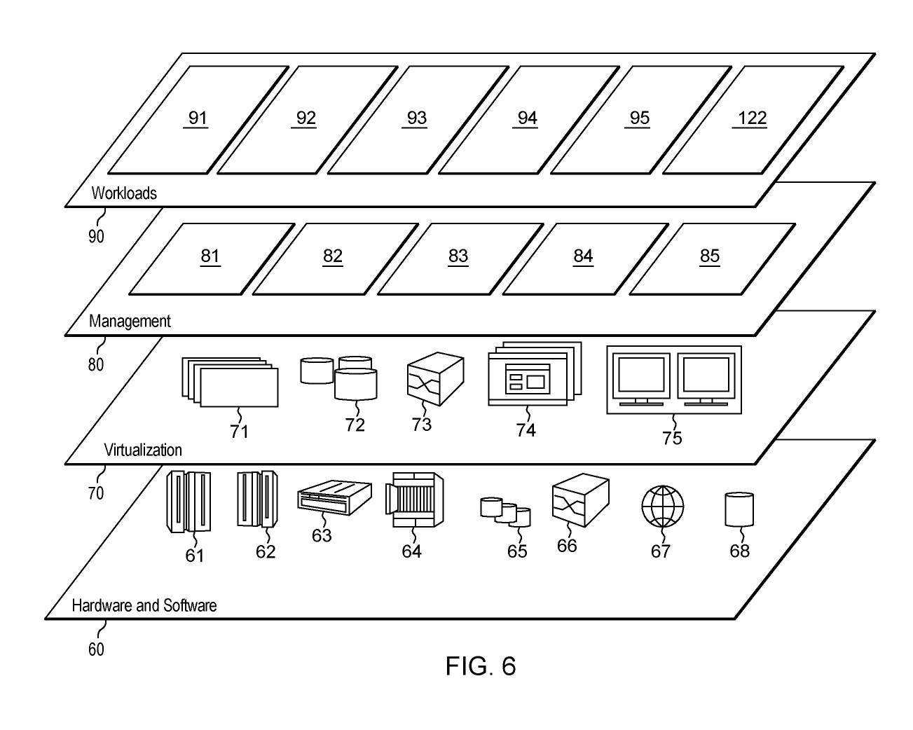

Servers 120, 130A, and 130B may each be a server, a management server, a web server, a mainframe computer, or any other electronic device or computing system capable of receiving, sending, and processing data. In various embodiments, servers 120, 130A, and 130B represent a computing system utilizing clustered computers and components that act as a single pool of seamless resources as used in a cloud-computing environment, as depicted and described in further detail with respect to FIGS. 5 and 6. In some embodiments, servers 120, 130A, and 130B can be a laptop computer, a tablet computer, a netbook computer, a notebook computer, a mobile computing device, a personal computer (PC), a desktop computer, a personal digital assistant (PDA), a smartphone, or any programmable electronic device capable of communicating with each other and other associated electronic devices, such as sensors, recording devices, or a network of beacons via network 110. Servers 120, 130A, and 130B may include internal and external hardware components, as depicted and described in further detail with respect to FIG. 4. As depicted in FIG. 1, server 120 includes cognitive merchandising system 121 with cognitive analysis program 122, and storage 125.

Cognitive merchandising system 121 on server 120 includes cognitive analysis program 122 and storage 125 with customer behavior database 127 and music database 128. In various embodiments, cognitive merchandising system 121 receives from server 130A and server 130B data on customer behavior observed in a retail location associated with each of server 130A and server 130B respectively. Cognitive merchandising system 121 stores received customer behavior data in customer behavior database 127. Similarly, cognitive merchandising system 121 receives from server 130A and server 130B data on music played in each of the retail locations associated with server 130A and 130B respectively and stores the data in music database 128. In various embodiments, cognitive merchandising system 121 using cognitive analysis program 122 analyzes data on customer behavior correlated to the music played to determine musical elements or recommended music associated with a received request for one or more desired customer behaviors.

Cognitive analysis program 122 includes programming code and routines to provide a method to retrieve, analyze, and correlate data on observed customer behavior with associated data on background music played in each retail location in one or more associated retail locations. A retail location includes, for example, a store, a restaurant, a bar, a mall, an art gallery, an event, such as an antique show, or any other retail environment. One or more associated retail locations may be one or more retail locations in a retail chain, a retail location associated or owned by a same entity or person, and the like. Observed customer behavior may include, but is not limited to, a length of a visit or dwell time in a retail location or a department, a number of purchases, a value of purchases, a number of garments tried on, and the like.

Cognitive analysis program 122 retrieves and analyzes data on observed customer behavior in one or more retail locations and data on background music played in a retail location from customer behavior database 127 and music database 128 respectively. In various embodiments, cognitive analysis program 122 receives a request for one or more desired customer behaviors from a user or a merchandiser via user interface (UI) 136 in server 130A or 130B. Cognitive analysis program 122 may utilize cognitive computing methodologies, machine learning, and artificial intelligence (AI) computing techniques, such as deep forward or recurrent neural networks, and other similar computing techniques, to analyze received or retrieved data on customer behavior and received or retrieved data on background music played in one or more retail locations with respect to one or more desired customer behaviors. Using various cognitive and AI computing intelligence techniques, cognitive analysis program 122 correlates data on background music and observed customer behaviors to provide an understanding of the influence or effect of music as a customer behavioral trigger in a retail environment.

In various embodiments, based, at least in part, on the analysis of observed customer behavior and background music, cognitive analysis program 122 provides recommended background music or a music playlist most likely to promote one or more desired customer behaviors in a retail chain or in a retail location. In various embodiments, cognitive analysis program 122 provides recommended background music to one or more of servers 130A, 130B, and to any other computing devices associated with one or more retailers (not depicted) via network 110. Cognitive analysis program 122 as depicted in FIG. 1 resides on server 120 which may be a part of cloud computing environment, in other embodiments, cognitive analysis program 122 resides on server 130A, 130B, or another computing device associated with one or more retailers (not depicted in FIG. 1).

Storage 125 in server 120 includes customer behavior database 127 and music database 128. In various embodiments, storage 125 includes one or more databases capable of storing data received from server 130A, server 130B, and other computing devices (not depicted). Customer behavior database 127 stores data on customer behavior including one or more of video data, location tracking data (e.g., global positioning system (GPS) data, indoor positioning system data, beacon/radio frequency (RF) tag tracking data, and the like), point of purchase data, store entry/exit data, time of purchase, time of customer entry/exit, and other customer data as provided by on location monitors, sensors, point of sale devices, and any other observed or recorded data related to customer behavior.

Music database 128 stores information or data on background music played in each retail location (e.g., store A and store B). The stored information or data on background music may include one or more of a music playlist, metadata on the background music, such as music titles and/or music genre, and a time when each musical piece is played within a retail location. In an embodiment, storage 125 resides on one or more computing devices (not shown in FIG. 1). In some embodiments, customer behavior database 127, music database 128, and/or storage 125 may reside in another computing device (not depicted) within distributed data processing environment 100. Storage 125 may send and/or receive data from cognitive analysis program 122, customer program 131, music program 133, and UI 136 on servers 130A and 130B.

In an embodiment, servers 130A and 130B each reside in a different physical retail or store location. For example, server 130A resides in store A, and server 130B resides in store B. In various embodiments, distributed data processing environment 100 includes a plurality of servers (not depicted) in a plurality of associated retail locations. In various embodiments, servers 130A and 130B include customer program 131, music program 133, storage 135, and UI 136. In various embodiments, customer program 131 receives data on observed customer behavior in a retail location. The observed customer behavior may be extracted using known digital image analysis or tracking techniques from one or more sources, such as digital multimedia data including video and camera digital images, sensor data including beacon, radio frequency identification (RFID) tags, location tracking associated with a customer account or loyalty account sign-in, point of sale data on purchases, and the like. The received data on customer behavior includes a time of the observed customer behavior. In an embodiment, customer program 131 compiles and analyzes the received customer data before sending to server 120. In various embodiments, customer program 131 sends the captured digital image data, sensor data, purchase information, and other as captured customer behavior data to customer behavior database 127 in storage 125 in server 120. In some embodiments, customer program 131 analyzes captured data, such as digital image, sensor data, or point of sale data and sends a summation of the determined customer behavior to customer behavior database 127 in storage 125. For example, customer program 131 may send customer behavior data from server 130A communicating that the average customer dwell time in Store A for March 3^{rd} was two hours, and the total number of sales for March 3^{rd} was 215 sold items.

Music program 133 residing on servers 130A and 130B provides background music and records data on background music played. In various embodiments, music program 133 executes music playlists, a music service, or an app for background music, controls music parameters, such as volume and music playing by department or area in an audio system for a retail location. In an embodiment, music program 133 may retrieve from storage 135 in server 130A or 130B for the respective retail location, at least one of data for digital music associated with a playlist, a link to music service provider, a link to music service or an app with a specified style of music, or the like. In various embodiments, music program 133 using known computer algorithms and programming code analyzes music played in a location to determine data, such as music genre, music title, music tempo, volume played, composer, and the like associated with the played music. In some embodiments, music program 133 is not present and a user inputs and sends data on music played in a retail location to server 120. In various embodiments, music program 133 sends data on background music played in a retail location to server 120 and receives data on recommended background music from server 120. In an embodiment, music program 133 may send and receive data on background music from storage 135 on server 130A or server 130B.

Storage 135 may include one or more databases capable of locally storing data on customer behavior including one or more of video data, beacon/radio frequency (RF) tag tracking data, point of purchase data, store entry/exit data, background music, and other data captured by respective store sensing devices, programs, and systems associated with servers 130A and 130B respectively. In an embodiment, storage 135 resides on one or more computing devices (not shown in FIG. 1). Storage 135 may receive and/or provide data to and from server 120 including observed customer behavior and recommended music playlists. In an embodiment, storage 135 may reside in another data storage device or devices (not depicted).

UI 136 provides an interface for users of server 130A and server 130B with server 120. In one embodiment, UI 136 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. UI 136 enables a user operating server 130A or server 130B to send requests for one or more desired customer behaviors to server 120.

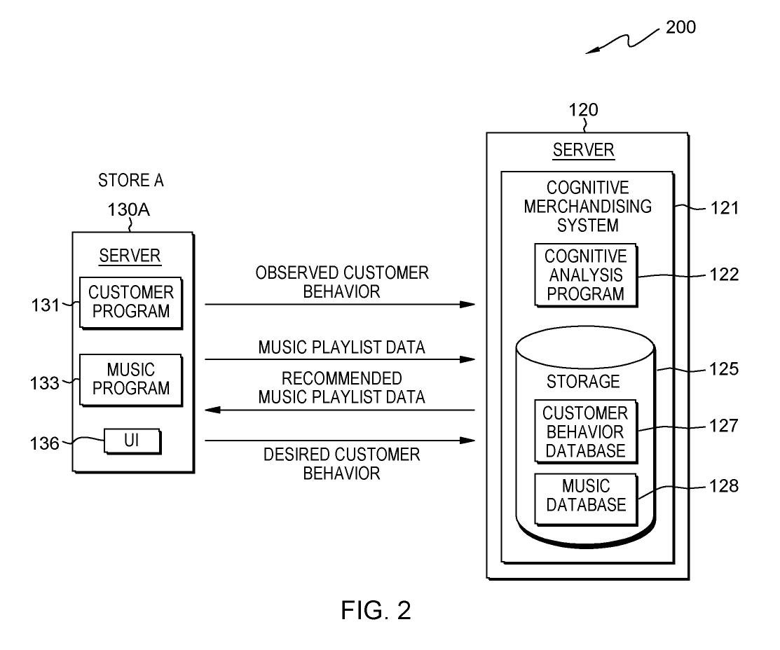

FIG. 2 is an illustration 200 of an example of data exchanged between server 130A and server 120 hosting cognitive merchandising system 121, in accordance with an embodiment of the present invention. As depicted, illustration 200 includes store A with server 130A hosting customer program 131, music program 133, and UI 136, and server 120 with cognitive merchandising system 121, cognitive analysis program 122, and customer behavior database 127, and music database 128 in storage 125. Each specific retailer location, such as store A including server 130A, sends music playlist data on background music played in the retailer location to music database 128 in cognitive merchandising system 121. The music playlist data or data on music played in store A sent to music database 128 may include one or more of the following: a time played, a file of digitized music played, a name of an app or a music service used with any specific style or type of music played, a list of music played, or meta data on music played including one or more of a time of play, a list of music names of music played, a music style or genre, a volume played, one or more locations played, a tempo, a day played, and the like.

Each retailer location, such as store A using server 130A, sends data on customer behavior observed in the retailer location to customer behavior database 127 in cognitive merchandising system 121 along with a timestamp for the observed customer behavior. In various embodiments, customer program 131 on server 130A collects data on observed customer behavior directly from collection devices, such as digital cameras, sensors, point of sales devices, and the like. Customer program 131 on server 130A sends observed customer behavior data to server 120 which may include at least one of a number of purchases by store or by department, a value of purchases by store or by department, a type of purchased item, a number of items taken to fitting rooms, customer dwell time in the retailer location, customer dwell time in a retailer department, and the like.

In various embodiments, the data on observed customer behavior is provided for a timeframe (e.g., from 2 pm to 2:30 pm, for a day, etc.). In some embodiments, customer program 131 collects or retrieves digital data, such as digital video data, digital image data, location data from mobile device GPS data, or sensor data, such as beacon data on customer location provided by an in-store network of beacons and the like to send to customer behavior database 127 in cognitive merchandising system 121 on server 120. In one embodiment, cognitive analysis program 122 retrieves data on observed customer behavior provided and stored in customer behavior database 127 in response to customer location tracking from a location determination system (e.g., GPS or indoor positioning system) associated with a store rewards program. The data sent on observed customer behavior may be metadata extracted from sensor data, digital recording device data, or point of sale device data, for example. The observed customer behavior is recorded with an associated time and sent to cognitive merchandising system 121 on server 120 for storage in customer behavior database 127.

A user, such as a merchandiser associated with store A, uses UI 136 to send a request from server 130A to cognitive analysis program 122 in cognitive merchandising system 121 for one or more desired customer behaviors, such as an increase in the number of purchases in store A, during business lunch hours. In response to the received query, cognitive analysis program 122 retrieves and correlates customer behavior from customer behavior database 127 and background music from music database 128 for each store associated with the query using a timestamp. Analyzing the number of purchases from the observed customer behavior using classifiers, statistical learning methods, and other cognitive analytical tools by associated background music and time for all stores associated with the query, cognitive analysis program 122 determines a recommended list of background music most likely to produce the desired customer behavior for the requested timeframe for store A. For example, cognitive analysis program 122, in response to the received request for a desired customer behavior, such as an increase in the number of purchases, sends to music program 133 on server 130A a music playlist most likely to trigger increased purchases during a business lunch hour for store A. Cognitive analysis program 122 determines the recommended music playlist based on using the analysis of the correlated customer behavior and music played in store A and associated stores (e.g., store B) during lunch hour.

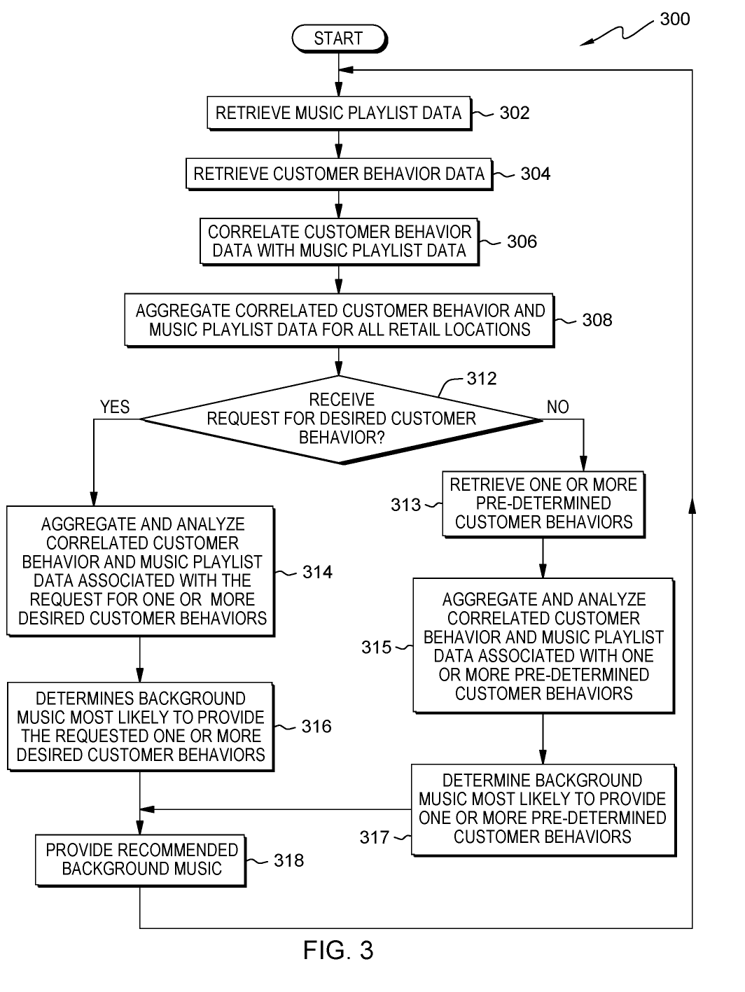

FIG. 3 is a flow chart 300 depicting a method for cognitive analysis program 122 to evaluate background music as a merchandising parameter influencing customer behavior, in accordance with an embodiment of the present invention. As depicted, FIG. 3 includes the steps of an embodiment of cognitive analysis program 122 to evaluate observed customer behavior and associated background music played in one or more retail locations to determine a recommendation for background music most likely to provide a desired customer behavior.

Cognitive analysis program 122 retrieves music playlist data (302) for background music played in a retail location from music database 128. In various embodiments, the music playlist data is data associated with music played in a retail location that includes a time music is played and information on the background music played, such as metadata associated with the music played in a retail location. The data associated with the background music played includes at least one or more of the following: a list of music names, a time of play, a music genre, a volume of music played, a location or department where the music played, a date of play, a tempo, a scale, a variation of tempo or tone, and other similar information on music attributes or musical elements of the background music played. In one embodiment, a file of digitized background music or a list of played background music is retrieved and analyzed by cognitive analysis program 122 to determine the music genre, tempo, the scale, and the like using known music analysis programs or algorithms for music analysis. In various embodiments, cognitive analysis program 122 retrieves music playlist data from music database 128 for each retail location within a retail chain of associated retail locations or from a single retailer with one location. In one embodiment, cognitive analysis program 122 retrieves music playlist data from music database 128 for each retail location within a group of associated retail chains (e.g., XYZ stores and ABC stores with common ownership or affiliation). In one embodiment, cognitive analysis program 122 receives music playlist data from each of server 130A and 130B.

Cognitive analysis program 122 retrieves observed customer behavior data (304) from customer behavior database 127. In various embodiments, cognitive analysis program 122 retrieves data associated with customer behavior observed in each retail location within a retail chain, in each retail location within a group of associated retail chains (e.g., XYZ stores and ABC stores with common ownership or affiliation), or from a retailer with a single retail location. The observed customer behavior data may include at least one or more of the following: a number of purchases by retail location, a number of purchases by department, a value of purchases by store or department, types of items purchased, an average customer dwell time in the store, an average customer dwell time in a department, and the like along with an associated time for the observed customer behavior. In various embodiments, cognitive analysis program 122 retrieves customer behavior data specific to a received merchandiser input (e.g., retrieve total purchase value by store) or a pre-set parameter such as customer behavior data by region, by one or more products, or the like associated with a default or pre-determined desired customer behavior.

In an embodiment, the retrieved customer behavior data includes digital image data from digital video recording devices or digital cameras received from each retail location (e.g., received from customer program 131 in servers 130A and 130B). In various embodiments, cognitive analysis program 122 includes known algorithms and methods for facial and object recognition to extract data on observed customer behavior from retrieved or received digital image data from in retail location digital recording devices or cameras. In an embodiment, cognitive analysis program 122 extracts an average customer in-store dwell time from retrieved digital image data received from retail location entry/exit cameras or digital recording devices in store A and store B. In an embodiment, cognitive analysis program 122 retrieves data extracted from a network of sensors or beacons to analyze for an average customer dwell time in a retail location or in a department of a retail location (e.g., store A) from customer behavior database 127. In some embodiments, cognitive analysis program 122 retrieves sensor data from a network of beacons from customer behavior database 127 or receives directly from customer program 131 on server 130A. In an embodiment, cognitive analysis program 122, using known sensor or beacon analysis algorithms for sensor data from a network of beacons, analyzes beacon data to determine customer behavior, such as locational changes and dwell time in a store or a department in a store, and the like.

In one embodiment, cognitive analysis program 122 retrieves information on customer behavior extracted from customer location data collected in association with a customer initiated or subscription to a customer loyalty or rewards program. In an embodiment, the observed customer behavior retrieved by cognitive analysis program 122 includes data on on-site purchases made through an on-line retail outlet, website, or app associated with the retail location. Purchases on the retail chain or retail store website using an Internet connection on a customer smartphone made while the customer is physically in store A may be captured using customer loyalty programs, mobile device location, store credit cards, or other similar methods. For example, a customer who has initiated a customer rewards app for a customer reward program while shopping in store A finds a desired style of golf shoes not stocked in his size. While viewing the golf shoes and style number, the customer initiates on an app for an on-line purchase of the desired golf shoe in the required size. In one embodiment, cognitive analysis program 122 retrieves from storage 125 customer behavior data for a predetermined or a determined timeframe (e.g., a day, a week, or an hour).

Cognitive analysis program 122 correlates customer behavior data with music playlist data (306) for the played background music in a retail location. Using a time of play, timestamps, time of purchase data, a timeframe, or other similar measure of time associated with or included in retrieved music playlist data and retrieved observed customer behavior, cognitive analysis program 122 matches one or more observed customer behaviors with the music playlist data for the background music playing at a retail location when the observed customer behavior occurs. For example, a retrieved customer behavior for store A from 3 to 4 pm on May 1^{st} includes the number of pairs of black shoes purchased (e.g., twenty pairs of black shoes). Using the timeframe 3 to 4 pm on May 1^{st}, cognitive analysis program 122 matches the music playlist data for the music played in store A using the time of 3 to 4 pm on May Pt to a corresponding customer behavior which is the number of pairs of black shoes purchased (e.g., twenty pairs). Another example of a retrieved customer behavior for store A from 3 to 4 pm includes a total value of purchases of $11,450. In various embodiments, cognitive analysis program 122 sends correlated data on observed customer behavior and music playlist data to storage 125.

Cognitive analysis program 122 aggregates correlated customer behavior and music playlist data for all retail locations (308) associated with the retail location (e.g., store A). In various embodiments, cognitive analysis program 122 aggregates each customer behavior and music playlist data for all retail locations associated with store A.

Cognitive analysis program 122 determines whether cognitive analysis program 122 receives a request for a desired customer behavior (decision 312) input by a user on UI 136. In various embodiments, cognitive analysis program 122 receives a request for one or more desired customer behaviors (yes branch, decision 312) by a user, such as a merchandiser on UI 136 or a music service provider (e.g., for a marketing study on music to provide to various retailers). For example, cognitive analysis program 122 receives a request from a user associated with a restaurant chain who desires to experience a high number of sales of dinner orders on seafood and wine in all restaurant locations in the restaurant chain from 8-10 pm. In an embodiment, cognitive analysis program 122 receives a request that includes one or more desired customer behaviors associated with a specified retail location(s). For example, cognitive analysis program 122 may receive a request for a desired customer behavior, such as a large number of sales of white shirts in store A and store B received from a merchandiser using UI 136 in store A.

Responsive to receiving a request for desired customer behavior, cognitive analysis program 122 aggregates and analyzes correlated customer behavior and music playlist data corresponding to the request for one or more desired customer behaviors (314). For example, cognitive analysis program 122 aggregates and analyzes correlated customer behavior and music playlist data to determine patterns in observed customer behavior associated with music playlist data. In various embodiments, cognitive analysis program 122 extracts music playlist data associated with observed customer behaviors matching requested desired customer behavior(s).

In various embodiments, cognitive analysis program 122 evaluates the request for the desired customer behavior to determine the scope of the request for one or more desired customer behaviors to provide a response most likely to provide one or more desired customer behaviors for the indicated retail location(s) at the time requested if included in the received request. In various embodiments, using known natural language processing (NLP), semantic analysis, and other similar computational linguistics methods, cognitive analysis program 122 determines the elements or scope of the received request (e.g., one or more retail locations included in the received request). For example, cognitive analysis program 122 analyzes the request for one or more desired customer behaviors and determines at least one of a desired customer behavior(s), a time or a timeframe for the desired customer behavior, one or more retail locations for the desired customer behavior, a target product associated with the desired customer behavior, and the like.

Upon determining the scope (e.g., number of retail locations, a time, a desired customer behavior, etc.) of the request for one or more desired customer behaviors, cognitive analysis program 122 retrieves from storage 125 correlated customer behavior and music playlist data associated with the request. In various embodiments, cognitive analysis program 122 retrieves the correlated customer behavior and music playlist data associated with one or more retail locations, a time or timeframe (e.g., a high customer store dwell time on Saturdays from Sam to 2 pm), etc. included in a request for desired customer behavior. For example, in response to receiving a request for a large number of purchases in all retail locations associated with store A from 8-11 am, cognitive analysis program 122 retrieves from storage 125 correlated customer behavior (e.g., number of purchases) and music playlist data with a timestamp between Sam and 11 am for all retail locations associated with store A. In various embodiments, cognitive analysis program 122 matches one or more desired customer behaviors (e.g., the largest number of purchases) for the indicated time with retrieved data on one or more observed customer behaviors (e.g., number of purchases from 8 to 11 am) for each store or retail location in the request (e.g., for all retail locations in the retail chain). Cognitive analysis program 122 extracts the music playlist data associated with the day with the largest number of observed customer behaviors (e.g., purchases) for each of the retail locations during the hours 8 to 11 am.

Using the correlated customer behavior and music playlist data aggregated according to the request for one or more desired customer behaviors, cognitive analysis program 122 extracts music playlist data from each retail location corresponding to the observed customer behavior matching the requested customer behavior(s). In various embodiments, cognitive analysis program 122 aggregates correlated customer behavior and music playlist data based on the received request for one or more desired customer behaviors (e.g., by a requested group of retail locations, by a timeframe, etc.). For example, cognitive analysis program 122 compares and analyzes the music playlist data extracted from each retail location that correspond to the requested desired customer behavior (e.g., the highest number of purchases) for an identified timeframe (e.g., 8-11 am) to determine commonality or elements of the music playlist data that are similar or the same across the various store locations when a high number of purchases occur. Continuing with the above example, cognitive analysis program 122 evaluates and compares the music playlist data from each store on the day with the highest number of sales from 8 to 11 am determines that classical music is most commonly played when the highest number of sales occur. Cognitive analysis program 122 may further determine, based on the analysis of music playlist data from 8 to 11 am on days of the highest number of purchases, that music composed by Mozart was the most commonly played music when the highest number of sales occurred.

In various embodiments, cognitive analysis program 122 utilizes AI techniques and known cognitive analysis methodologies to analyze music playlist data associated with one or more desired customer behaviors. For example, cognitive analysis program 122 may determine one or more musical elements, such as a music genre, scale, tempo, volume played, or the like associated with desired customer behavior by determining observed customer behaviors matching one or more desired customer behaviors. Cognitive analysis program 122 extracts music playlist data correlated to observed customer behaviors matching desired customer behaviors to analyze and determine similarities in the correlated music playlist data (e.g., similar music style, similar music tempo, same music titles, etc.). Additionally, cognitive analysis program 122 may extract and determine further information associated with music playlist data such as common composer or a time of music composition or music release (e.g., composed in the 1920's or released the last six months). For example, cognitive analysis program using one or more known music analysis algorithms or using information extracted from music playlist data may retrieve from a music database or an internet source using information from music playlist data associated a requested desired customer behavior (e.g., querying for a composer for a music composition or song).

In some embodiments, cognitive analysis program 122 provides the ability to analyze retrieved data, such as demographic data for each retail location (e.g., store A) and determine one or more retail locations to aggregate together, based at least in part, on demographic data when no specific retail locations are included in the received request for desired customer behavior. For example, cognitive analysis program 122 may retrieve from a database or an internet source, demographic data associated with each retail location included in a received request for desired customer behavior from a UI of merchandiser in store A. For example, cognitive analysis program 122 determines an aggregation of correlated customer behavior data and music playlist data based, at least in part, on one or more elements of retrieved demographic or geographic data from an external database, such as a government census database or the like (e.g., determines retail locations with nearby populations with a similar average age, a similar average income, a similar Midwest location, retail locations within a set distance or area, or a combination of various demographic data elements). Using machine learning and/or other AI techniques, cognitive analysis program 122 may determine one or more retail locations to aggregate in the analysis of historical data on similarities in trends and correlated customer behavior and music playlist data associated with similar retrieved demographic data and/or geographic data when no specific retail locations are identified in the request for customer behavior.

In one embodiment, cognitive analysis program 122 determines one or more timeframes to aggregate the correlated customer behavior and music playlist data when a timeframe is not included in a received request for desired customer behavior. Cognitive analysis program 122 based, at least in part, on an analysis of correlated customer behavior and music playlist data for one or more retail locations may determine one or more timeframes providing similar trends in observed customer behavior. For example, cognitive analysis program 122, upon evaluating correlated customer behavior and music playlist data, determines that for the retail locations associated with store A, a trend in customer behavior and music playlist data is determined in the hours between 7 and 9 pm and another trend in customer behavior and music playlist is observed between 10 am and 5 pm. Based on the evaluation of historical, observed customer behavior and associated music playlist data in various retail locations associated with store A, cognitive analysis program 122 automatically determines an analysis of customer behavior and music playlist data be aggregated using two timeframes (e.g., 10 am-5 pm and 7-9 pm) for the retail locations associated with store A.

Cognitive analysis program 122 determines background music most likely to provide the requested one or more desired customer behaviors (316). Using the results of the analysis of aggregated and correlated customer behavior and music playlist data associated with the request for one or more desired customer behaviors, cognitive analysis program 122 introspects the desired customer behavior with the correlated customer behavior and music playlist data to determine background music most likely to influence observed customer behavior and provide the desired customer behavior. Based, at least in part, on the analysis of correlated customer behavior and music playlist data corresponding to the request for one or more desired customer behavior(s), cognitive analysis program 122, using machine learning and AI techniques, determines recommended background music most likely to provide the requested desired customer behavior(s).

For example, as discussed above with respect for the request for a desired customer behavior for a high number of purchases between 8 and 11 am in stores associated with store A in a retail chain, the analysis of the aggregated and correlated customer behavior and music playlist data with respect to the request determined that classical music is associated with the desired customer behavior. Furthermore, using with deeper cognitive or AI analysis of music playlist data that includes, for example, titles of music played, in the above example, cognitive analysis program 122 determines that music composed by Mozart is likely to provide the desired customer behavior. In an example, cognitive analysis program 122 extracts from music playlist data a composer for a played song. In various embodiments, cognitive analysis program 122 extracts information from music playlist data to retrieve additional data from a music database or an internet source to use in determining recommended background music. For example, cognitive analysis program 122 extracts a title for a musical composition from music playlist data and queries a music database or an Internet source for a composer of the composition. In an embodiment, cognitive analysis program 122 determines that there is no pattern or correlation between music and observed customer behavior providing a desired customer behavior and; therefore, no determination of recommended background music is provided.

Cognitive analysis program 122 provides recommended background music (318) to the one or more retail locations associated with the received request for a desired customer behavior. In various embodiments, cognitive analysis program 122 sends recommended background music most likely to provide the desired customer behavior to one or more computing devices, such as servers 130A and 130B. In various embodiments, cognitive analysis program 122 provides recommended background music to retail locations as one or more of the following: a music playlist, a file of digital music, a link to a music service (e.g., a link to a specific music genre in the music service), a genre of music, a music tempo, a music scale, a music volume, a name of a music app, a name of a music service, a composer, a timeframe of music composition, or as any other identification of a type of music or a list of music for recommended background music. Upon providing recommended background music to one or more retail locations, cognitive analysis program returns to step 302 to continue to iteratively monitor and analyze observed customer behaviors with respect to music played to identify music influencing customer behavior.

Responsive to determining that no requests for desired customer behavior are received (no branch, decision 312), cognitive analysis program 122 retrieves one or more pre-determined customer behaviors (313) from storage 125. In various embodiments, cognitive analysis program 122 receives an input on UI 136 from a user, such as merchandiser responsible for a retail location or a retail chain associated a retail location (e.g., store A) to use one or more pre-determined desired customer behaviors to be used as default to analyze correlated customer behavior and music playlist data. For example, a user or merchandiser associated with a retail chain provides an input for a pre-determined desired customer behavior, such as a high customer dwell time by day for a default for analyzing correlated customer behavior and music playlist data for the retail chain. In various embodiments, cognitive analysis program 122 stores the received pre-determined or default customer behavior for the retail chain in storage 125. In one embodiment, cognitive analysis program 122 includes a default customer behavior when no inputs for a pre-determined customer behavior are received. For example, when no inputs are received from a retail location for either a pre-determined customer behavior or a desired customer behavior, a default customer behavior for an analysis of observed customer and background music, such as a high purchase value is retrieved.

In various embodiments, cognitive analysis program 122 aggregates and analyzes correlated customer behavior and music playlist data associated with one or more pre-determined customer behaviors (315). Using the methods discussed above in step 314, in various embodiments, cognitive analysis program 122 determines the scope of the pre-determined customer behaviors (e.g., uses NLP to determine selected retail locations, timeframes, specified customer behaviors, etc.). Cognitive analysis program 122 extracts correlated customer behavior and music playlist data corresponding to the one or more pre-determined customer behaviors to determine the observed customer behaviors in the correlated customer behavior and music playlist data corresponding to the one or more pre-determined customer behaviors.

In an embodiment, cognitive analysis program 122 analyzes extracted music playlist data correlated to the observed customer behaviors matching the pre-determined customer behaviors. Using known statistical methods and cognitive computing algorithms, cognitive analysis program 122 analyzes background music played in one or more locations as a parameter in the determination of music elements in music playlist data influencing customer behavior.

Analyzing aggregated correlated customer behavior and music playlist data corresponding to the pre-determined customer behavior, cognitive analysis program 122 determines trends in observed customer behavior associated with played background music. For example, cognitive analysis program 122 evaluates observed customer behavior as compared to a pre-determined customer behavior to determine music playlist data for background music correlated to an observed customer behavior matching the pre-determined customer behavior. Based on identifying background music (e.g., music playlist data) associated with observed customer behaviors matching and/or similar to the pre-determined behavior, cognitive analysis program 122 analyzes the music playlist data to determine a type of music, a tempo, a volume, a music playlist, a music service or the like that may be used as trigger for an associated customer behavior using provided retail location. In a more specific example, cognitive analysis program 122 retrieves from storage 125 a pre-determined customer behavior of a high value of wine sales in a restaurant chain. The analysis of the days with the highest value of wine sales from each restaurant in the chain by cognitive analysis program 122 determines that jazz music was played at a low volume during the days of the highest value of wine sales.

In another example for the pre-determined customer behavior (e.g., highest value of wine sales) in the restaurant, cognitive analysis program 122 learns from multiple analyses of correlated customer behavior and music playlist data that in seasonal timeframes, such as the month of December, observed customer behavior, such as a high value of purchases, in general for various stores and various products, is correlated with music playlist data associated with holiday music and as a result, cognitive analysis program 122 may include holiday music in the recommended background music for the restaurant chain.

Cognitive analysis program 122 determines background music most likely to provide one or more pre-determined customer behaviors (317). Based on the analysis of aggregated and correlated customer behavior and music playlist data associated with the one or more pre-determined customer behaviors, cognitive analysis program 122 determines the background music most likely to provide one or more pre-determined customer behaviors. Using the method previously discussed in detail in step 316 (e.g., a method with respect to a received request for a desired customer behavior), cognitive analysis program 122, using the methods of step 316 applied to the analysis of one or more pre-determined customer behaviors, determines background music to provide one or more pre-determined behaviors.

Cognitive analysis program 122 provides recommended background music (318) to the retail locations associated with the pre-determined customer behavior. Cognitive analysis program 122 using the method discussed above with for step 318 provides recommended background music and then, returns to step 302.

In response to sending a recommended playlist to one or more retail locations, cognitive analysis program 122 returns to step 302 and iteratively repeats steps 302 to 318. Cognitive analysis program 122 is capable of applying known cognitive and machine learning methodologies to continually retrieve and analyze data on observed customer behavior and music playlist data gathered through multiple iterations of steps 302-318 for multiple clients, retail locations or retail chains. In various embodiments, cognitive analysis program 122 recognizes trends in the results of various analyses, such as seasonal customer behavior changes and changes in background music or music playlist data associated with seasonal changes. Cognitive analysis program 122 is capable of recognizing trends associated with historical analyses and in response to recognized trends, proactively provide recommended background music before or as a trend, such as a season is anticipated. For example, for a retail chain, cognitive analysis program 122 provides seasonal or holiday music as recommended background music for the retail chain on December 1 based, at least in part, on a number of previous analyses of correlated customer behavior and associated music playlist data (e.g., retail locations playing seasonal music in December observed a higher number of purchases).

In another example, cognitive analysis program 122, in response to a received customer request for a desired customer behavior, such as a high number of sales in junior departments of a retail chain, recognizes or determines that music playlist data correlated or associated with higher number of purchases on Fridays is different than the music playlist data associated with higher purchases on Monday through Thursday or the weekend. Responsive to the analysis indicating anomalous music playlist data associated with higher number of sales on Friday, cognitive analysis program 122 determines a different music playlist or different recommended background music for Fridays should be provided to the junior department of the retail chain.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

FIG. 4 depicts a block diagram 400 of components of a computer system, which is an example of a system, such as server 120, server 130A, or server 130B within distributed data processing environment 100, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server 120, server 130A, and server 130B each can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410 and input/output (I/O) interface(s) 412. Communications fabric 402 can be implemented with any architecture designed for passing data and/or control information between processors (such as microprocessors, communications and network processors, etc.), system memory, peripheral devices and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data and near recently accessed data, from memory 406.

Program instructions and data used to practice embodiments of the present invention are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory or any other computer readable storage media that is capable of storing program instructions or digital information.

The media used by persistent storage 408 may also be removable. For example, a removable hard drive may be used for persistent storage 408. Other examples include optical and magnetic disks, thumb drives and smart cards that are inserted into a drive for transfer onto another computer readable storage medium that is part of persistent storage 408.

Communications unit 410, in these examples, provides for communications with other data processing systems or devices, including resources of server 120, server 130A and server 130B and other computing devices not shown in FIG. 1. In these examples, communications unit 410 includes one or more network interface cards. Communications unit 410 may provide communications with either or both physical and wireless communications links. Program instructions and data used to practice embodiments of the present invention may be downloaded to persistent storage 408 through communications unit 410.

I/O interface(s) 412 allows for input and output of data with other devices that may be connected to server 120, server 130A or server 130B. For example, I/O interface(s) 412 may provide a connection to external device(s) 416 such as a keyboard, a keypad, a touch screen, a microphone, a digital camera and/or some other suitable input device. External device(s) 416 can also include portable computer readable storage media, for example, devices such as thumb drives, portable optical or magnetic disks and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops and PDAs).

Resource pooling: the providers' computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems or storage, but has control over the deployed applications and possibly application hosting environment configurations.

Infrastructure as a Service (IaaS): the capability provided to the consumer is to provision processing, storage, networks and other fundamental computing resources where the consumer is able to deploy and run arbitrary software, which can include operating systems and applications. The consumer does not manage or control the underlying cloud infrastructure but has control over operating systems, storage, deployed applications and possibly limited control of select networking components (e.g., host firewalls).

Deployment Models are as follows:

Private cloud: the cloud infrastructure operates solely for an organization. It may be managed by the organization or a third party and may exist on-premises or off-premises.

Community cloud: the cloud infrastructure is shared by several organizations and supports a specific community that has shared concerns (e.g., mission, security requirements, policy and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing between clouds).

A cloud computing environment is service oriented with a focus on statelessness, low coupling, modularity and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that cloud computing nodes 10 and cloud computing environment 50 can communicate with any type of computerized device over any type of network and/or network addressable connection (e.g., using a web browser). In embodiments of the present invention, the computer system depicted by block diagram 400 may be representative of a cloud computing node 10.

Referring now to FIG. 6, a set of functional abstraction layers provided by cloud computing environment 50 (FIG. 5) is shown. It should be understood in advance that the components, layers and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65 and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74 and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95 and cognitive analysis program 122.

The programs described herein are identified based upon the application for which they are implemented in a specific embodiment of the invention. However, it should be appreciated that any particular program nomenclature herein is used merely for convenience and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data or either source code or object code written in any combination of one or more programming languages, including an object oriented programming language such as Smalltalk, C++ or the like and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams and combinations of blocks in the flowchart illustrations and/or block diagrams, can be implemented by computer readable program instructions.

These computer readable program instructions may be provided to a processor of a general purpose computer, a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device. The computer readable program instructions may cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently or the blocks may sometimes be executed in the reverse order, depending upon the functionality involved. It will also be noted that each block of the block diagrams and/or flowchart illustration and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace or to enable others of ordinary skill in the art to understand the embodiments disclosed herein.

What is claimed is:

1. A method to determine music to influence customer behavior, the method comprising:
retrieving, by one or more computer processors, customer behavior in a retail location and data associated with music played in the retail location, wherein the retail location is one of a plurality of retail locations;
correlating, by one or more computer processors, by time, customer behavior in the retail location with the data associated with music played in the retail location for each retail location of the plurality of retail locations;
receiving, by one or more computer processors, a request for one or more desired customer behaviors in at least one of the plurality of retail locations;
determining, by one or more computer processors, music that provides the one or more desired customer; and
providing, by one or more computer processors, a recommendation of the music that provides the one or more desired customer behaviors to the at least one of the plurality of retail locations associated with the request for the one or more desired customer behaviors.

2. The method of claim 1, wherein data associated with music played in the retail location includes a time of play for music and at least one of a file or metadata.

3. The method of claim 1, wherein customer behavior in the retail location includes a time of an observed customer behavior wherein the observed customer behavior is determined using one or more sensors, one or more video cameras, one or more point of sale devices, a customer reward program, and one or more location determination systems.

4. The method of claim 1, wherein customer behavior in the retail location includes at least one of: a number of purchases for the retail location, a number of purchases by department in the retail location, a value of purchases, a value of purchases by department, a type of product purchased, a type of product purchased by department, a customer dwell time in a store, a customer dwell time by department, and a number of items tried on by department.

5. The method of claim 1, wherein receiving the request for the one or more desired customer behaviors in at least one of the plurality of retail locations further comprises determining, by one or more computer processors, one or more of a time associated with the one or more desired customer behaviors, one or more departments associated with the one or more desired customer behaviors, and one or more products associated with the one or more desired customer behaviors.

6. The method of claim 1, wherein the recommendation of the music is at least one of: a music playlist, a file of digital music, a genre of music, a link to a music app with a specified style of music, or a link to a music service with a specified style of music.

7. The method of claim 1, wherein determining, by one or more computer processors, music that provides the one or more desired customer behaviors further comprises:
determining, by one or more computer processors, a scope of the request for the one or more desired customer behaviors;
determining, by one or more computer processors, one or more observed customer behaviors matching the one or more desired customer behaviors;
extracting, by one or more computer processors, data on the music played in the at least one retail location; and
determining, by one or more computer processors, the music that provides the one or more desired customer behaviors, based, at least in part, on an analysis of similarities in the data on the music played to when the one or more observed customer behaviors match the one or more desired customer behaviors.

8. The method of claim 7, wherein determining the one or more observed customer behaviors matching the one or more desired customer behaviors further comprises:
determining, by one or more computer processors, a number of the one or more observed customer behaviors matching the one or more desired customer behaviors within a timeframe;
determining, by the one or more computer processors, the timeframe with a largest number of the one or more observed customer behaviors matching the one or more desired customer behaviors; and
analyzing, by one or more computer processors, data on music played when the timeframe with the largest number of the one or more observed customer behaviors matches the one or more desired customer behaviors.

9. The method of claim 1, wherein correlating, by time, customer behavior in the retail location with the data associated with music played in the retail location for each retail location of the plurality of retail locations further comprises:
retrieving, by one or more computer processors, one or more pre-determined customer behaviors; and
determining, by one or more computer processors, music that provides the one or more pre-determined customer behaviors based, at least in part, on the correlated customer behavior and the data associated with music played in the retail location.

10. A computer program product to determine music to influence customer behavior, the computer program product comprising:
one or more computer readable storage media and program instructions stored on the one or more computer readable storage media, the program instructions executable by a processor, the program instructions comprising instructions for:
retrieving, by one or more computer processors, customer behavior in a retail location and data associated with music played in the retail location, wherein the retail location is one of a plurality of retail locations;
correlating, by one or more computer processors, by time, customer behavior in the retail location with the data associated with music played in the retail location for each retail location of the plurality of retail locations;
receiving, by one or more computer processors, a request for one or more desired customer behaviors in at least one of the plurality of retail locations;
determining, by one or more computer processors, music that provides the one or more desired customer behaviors; and
providing, by one or more computer processors, a recommendation of the music that provides the one or more desired customer behaviors to the at least one of the plurality of retail locations associated with the request for the one or more desired customer behaviors.

11. The computer program product of claim 10, wherein data associated with music played in the retail location includes a time of play for music and at least one of a file or metadata.

12. The computer program product of claim 10, wherein customer behavior in the retail location includes a time of an observed customer behavior wherein the observed customer behavior is determine using one or more sensors, one or more video cameras, one or more point of sale devices, a customer reward program, and one or more location determination systems.

13. The computer program product of claim 10, wherein determining, by one or more computer processors, music that provides the one or more desired customer behaviors further comprises:
determining, by one or more computer processors, a scope of the request for the one or more desired customer behaviors;
determining, by one or more computer processors, one or more observed customer behaviors matching the one or more desired customer behaviors;
extracting, by one or more computer processors, data on the music played in the at least one retail location; and
determining, by one or more computer processors, the music that provides the one or more desired customer behaviors, based, at least in part, on an analysis of similarities in the data on the music played to when the one or more observed customer behaviors match the one or more desired customer behaviors.

14. The computer program product of claim 13, wherein determining one or more observed customer behaviors matching the one or more desired customer behaviors further comprises:
determining, by one or more computer processors, a number of one or more observed customer behaviors matching the one or more desired customer behaviors within a timeframe;
determining, by the one or more computer processors, the timeframe with a largest number of one or more observed customer behaviors matching the one or more desired customer behaviors; and
analyzing, by one or more computer processors, data on music played when the timeframe with the largest number of one or more observed customer behaviors matches the one or more desired customer behaviors.

15. The computer program product of claim 10, correlating, by time, customer behavior in the retail location with the data associated with music played in the retail location for each retail location of the plurality of retail locations further comprises:
retrieving, by one or more computer processors, one or more pre-determined customer behaviors; and
determining, by one or more computer processors, music that provides the one or more pre-determined customer behaviors based, at least in part, on the correlated customer behavior and the data associated with music played in the retail location.

16. A computer system comprising:
one or more computer processors;
one or more computer readable storage media; and
program instructions stored on the one or more computer readable storage media for execution by at least one of the one or more computer processors, the program instructions comprising instructions to perform:
retrieving customer behavior in a retail location and data associated with music played in the retail location, wherein the retail location is one of a plurality of retail locations;
correlating by time, customer behavior in the retail location with the data associated with music played in the retail location for each retail location of the plurality of retail locations;
receiving a request for one or more desired customer behaviors in at least one of the plurality of retail locations;
determining music that provides the one or more desired customer behaviors; and
providing a recommendation of the music that provides the one or more desired customer behaviors to the at least one of the plurality of retail locations associated with the request for the one or more desired customer behaviors.

17. The computer system of claim 16, receiving the request for one or more desired customer behaviors in at least one of the plurality of retail locations further comprises determining, by one or more computer processors, one or more of a time associated with the desired customer behavior, one or more departments associated with the desired customer behavior, and one or more products associated with the desired customer behavior.

18. The computer system of claim 16, wherein determining music that provides the one or more desired customer behaviors further comprises:
determining a scope of the request for the one or more desired customer behaviors;
determining one or more observed customer behaviors matching the one or more desired customer behaviors;
extracting data on the music played in the at least one retail location; and
determining the music that provides the one or more desired customer behaviors, based, at least in part, on an analysis of similarities in the data on the music played to when the one or more observed customer behaviors match the one or more desired customer behaviors.

19. The computer system of claim 18, wherein determining one or more observed customer behaviors matching the one or more desired customer behaviors further comprises:
determining a number of one or more observed customer behaviors matching the one or more desired customer behaviors within a timeframe;
determining the timeframe with a largest number of one or more observed customer behaviors matching the one or more desired customer behaviors; and
analyzing data on music played when the timeframe with the largest number of one or more observed customer behaviors matches the one or more desired customer behaviors.

20. The computer system of claim 16, correlating, by time, customer behavior in the retail location with the data associated with music played in the retail location for each retail location of the plurality of retail locations further comprises:
retrieving one or more pre-determined customer behaviors; and
determining music that provides the one or more pre-determined customer behaviors based, at least in part, on the correlated customer behavior and the data associated with music played in the retail location.
